(19) United States
(12) Patent Application Publication
(10) Pub. No.: US 2009/0050393 A1
(43) Pub. Date: Feb. 26, 2009

(54) SEATBELT SAFETY SYSTEM

(75) Inventors: Oluwaseyi O. Oyerokun, Midland, TX (US); Robert V. Williamson, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/842,237

(22) Filed: Aug. 21, 2007

(51) Int. Cl. B60R 21/00

(52) U.S. Cl. 180/270

(57) ABSTRACT

Disclosed is a seatbelt safety system for an automobile that includes a latch mechanism configured to fixedly engage with a male of a seatbelt, a release button disposed on the latch mechanism that is configured to release the latch from engagement with the male member, an engagement sensor disposed with the latch mechanism that is configured to sense the engagement between the latch and the male member, a tamper sensor that is configured to sense any depression of the release button, and at least one transmitting device configured to transmit engagement and tamper data to at least one indication device, the at least one indication device being configured to provide a driver the engagement and tamper data, the indication device being disposed in a position that allows the driver to receive the engagement and tamper data.

### BACKGROUND OF THE INVENTION

1. Field of the Invention

The disclosure relates generally to a seatbelt safety system, and more particularly to a seatbelt safety system for an automobile.

2. Description of Background

A child who has been fastened to a car seat via a seatbelt may be able to access and depress a release button of the seatbelt without alerting the driver of the car. This poses a danger in that the child may be able to release him or herself from the fastened seatbelt via this button. Even seatbelt systems that include driver controlled locks may allow the child be released via depression of the release button if the driver has neglected to activate one or more of the locks. As such, a seatbelt system that alerts the driver to depression of the release button would be desirable.

### SUMMARY OF THE INVENTION

Disclosed is a seatbelt safety system for an automobile that includes a latch mechanism associated with at least one seat of the automobile, the latch mechanism being configured to fixedly engage with a male member secured to a restraining strap of a seatbelt disposed with at least one seat, a release button disposed on the latch mechanism, the release button being configured to release the latch mechanism from a fixed engagement with the male member, and an engagement sensor disposed with the latch mechanism, the engagement sensor being configured to sense the fixed engagement between the latch mechanism and the male member. The system also includes a tamper sensor disposed with the latch mechanism and the release button, the tamper sensor being configured to sense any depression of the release button, and at least one transmitting device configured to transmit engagement data sensed by the engagement sensor and tamper data sensed by the tamper sensor to at least one indication device, the at least one indication device being configured to provide a driver of the automobile with the engagement data and tamper data, and the at least one indication device being disposed in the automobile in a position that allows the driver to receive the engagement data and tamper data.

### BRIEF DESCRIPTION OF THE DRAWINGS

The foregoing and other features and advantages of the present invention should be more fully understood from the following detailed description of illustrative embodiments taken in conjuncture with the accompanying Figures in which like elements are numbered alike in the several Figures:

FIG. 1 is a schematic representation of a latching mechanism, seat, and seatbelt of a seatbelt safety system;

FIG. 2 is diagram illustrating the seatbelt safety system; and

FIG. 3 is a schematic representation of at least one indication device of the seatbelt safety system.

### DETAILED DESCRIPTION OF THE INVENTION

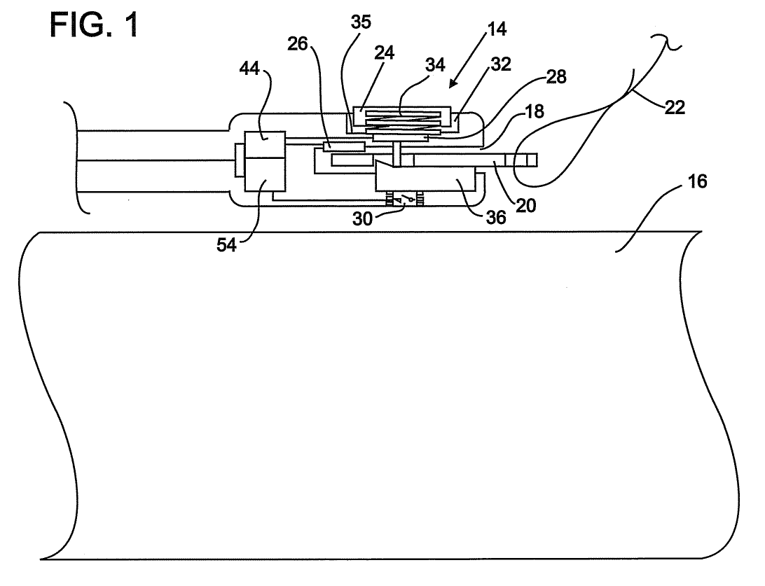

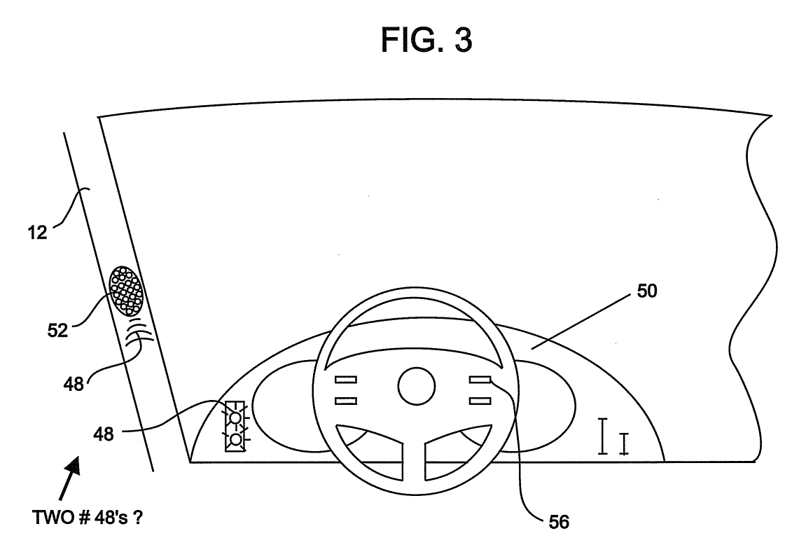

Referring to FIGS. 1-3, a seatbelt safety system 10 for an automobile 12 (partially shown in FIG. 3) is illustrated. The system 10 includes a latch mechanism 14 that is associated with at least one seat 16 of the automobile 12. Like most latch mechanisms known in the art, the latch mechanism 14 defines a latching cavity 18 that engages with a male member 20 of a seatbelt 22 to fasten the latching mechanism 14 to the male member 20, and thus, fasten a passenger in his or her seat 16. The latch mechanism 14 of the system 10 also includes a release button 24, engagement sensor 26, tamper sensor 28, and locking mechanism 30, as will be discussed in detail below beginning with the release button 24.

Referring to FIG. 1 in particular, the release button 24 is disposed in a recess 32 defined by a surface of the latch mechanism 14. A spring 34 associates the button 24 with an inner surface 35 of the recess 32, and allows the button to spring back to a non-depressed position (as shown in FIG. 1) following any depression. The release button 24 interacts with a catch element 36 within the latch mechanism 14. As with conventional seatbelts known to those skilled in the art, when the male member 20 is inserted in the latching cavity 18 (as shown in FIG. 1) the catch element 36 engages the male member 20 to securely and selectively hold the male member 20 (and thus seatbelt 22) and latch mechanism 14 in a locked engagement until such time that the release button 24 is pressed. It should be appreciated that while this specific means of engagement is disclosed in accordance with the exemplary embodiment of FIG. 1, those skilled in the art are certainly familiar with a variety of engagement mechanisms that may be employed without departing from the spirit of the disclosure.

With continued reference to FIG. 1 in particular, the release button 24 is configured with the tamper sensor 28, such that the tamper sensor 28 senses any depression of the release button 24. In the exemplary embodiment of FIG. 1, the tamper sensor 28 is disposed to sense compression of the spring 34, which is compressed in response to depression of the release button 24. By sensing compression of the spring 34, the tamper sensor 28 senses depression of the release button 24. As those skilled in the art will appreciate, sensors used to monitor spring compression are known to those skilled in the art, and any of these known sensors may be used with the spring 34 of FIG. 1.

Again referring to FIG. 1 in particular, the engagement sensor 26 and locking mechanism 30 are also disposed in the latch mechanism 14. The engagement sensor 26 is disposed within the latch mechanism 14 in a manner that allows the sensor 26 to sense locked engagement between the male member 20 and the catch element 36. As those skilled in the art will appreciate, sensors used to monitor proper latching of male seatbelt members with latch mechanisms are know to those skilled in the art, and any of these known sensor may be used with the latch mechanism 14 and male member 20 of FIG. 1. Furthermore, the locking mechanism 30 is disposed within the latch mechanism 14 in a manner that allows the locking mechanism 30 to lock the catch element 36 in locked engagement with the male member 20 regardless of depression of the release button 24. In accordance exemplary embodiment of FIG. 1, the locking mechanism 30 is an electromechanical locking structure that interferes with the standard latch mechanism to prevent disengagement of the male member 20 from the catch element 36. However, a variety of locking structures may be utilized within the spirit of the disclosure.

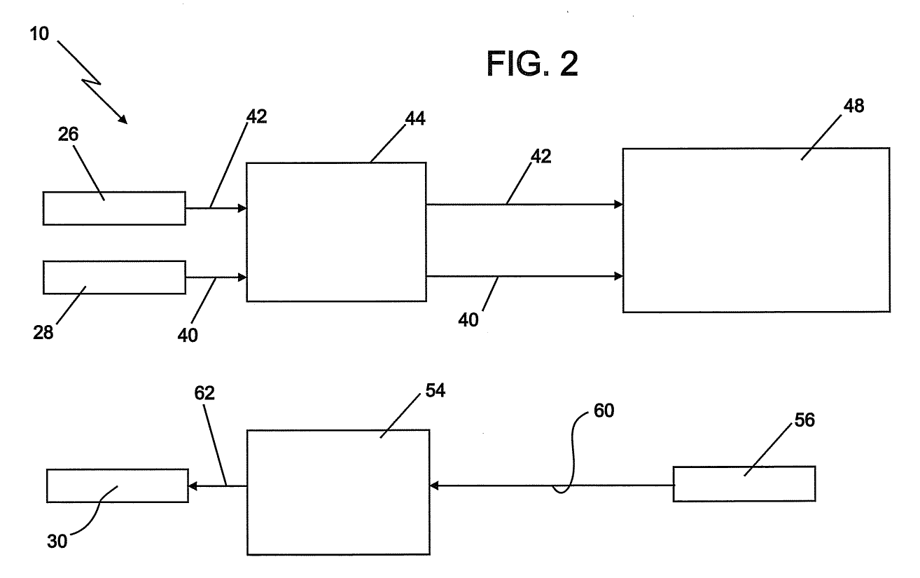

Referring now to FIG. 2 in particular, tamper data 40 and engagement data 42 are transmitted from the tamper sensor 28 and engagement sensor 26 to the transmitting device 44. In the exemplary embodiment of FIG. 1, the transmitting device 44 is located within the latch mechanism 14, though it should be appreciated that this device 44 may be disposed within the tamper and engagement sensors 28 and 26 themselves, or anywhere else in the automobile 12.

After receiving data from the tamper device 28 and or engagement device 26, the transmitting device 44 transmits the received tamper and engagement data 40 and 42 to an indication device 48. Referring to FIG. 3 in particular, the indication device 48 may be disposed on a dashboard information display 50 of the automobile 12. Disposal of the indication device 48 dashboard information display 50 allows a driver to be visually alerted to tamper data 40 and/or engagement data 42. Again referring to FIG. 3 in particular, the indication display device may also be disposed in association with an audio system (represented by speaker 52 in FIG. 3) of the automobile 12. Disposal of the indication device 48 audio system 52 allows a driver to be audibly alerted to tamper data 40 and/or engagement data 42 via various sound based indications. These alerts (be they audio and/or visual) allow the driver to know whether a passenger has fastened his or seatbelt, as well as whether a passenger (particularly a child passenger) is tampering with his or her fastened seatbelt by depressing the release button 24. It should be appreciated that any transmission between the sensors 26 and 28 and transmitting device 44, and/or the transmitting device 44 and indication device 48, may occur via any wired or wireless communication.

Referring back to FIG. 2, the locking mechanism 30 is in communication with a controller 54. The controller 54 is also in communication with a locking actuator 56, which is disposed in an area of the automobile 12 that is accessible to the driver (see FIG. 3). This actuator 56 allows the driver to activate or deactivate (i.e. lock or unlock) the locking mechanism 30 by transmitting a locking/unlocking signal 60 to the controller 54, which in turn transmits a command signal 62 to the locking mechanism 30. The locking mechanism 30 is locked or unlocked in response to receipt of this command signal 62. It should be appreciated that though the controller 54 is located within the latch mechanism 14 in the exemplary embodiment of FIG. 1, this controller 56 may be disposed within the locking mechanism 30 or actuator 56 themselves, or anywhere else in the automobile 12. It should be appreciated that any transmission between the controller 54 and locking mechanism 30, and/or the controller 54 and locking actuator 56, may occur via any wired or wireless communication.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A seatbelt safety system for an automobile, the system comprising:
a latch mechanism associated with at least one seat of the automobile, said latch mechanism being configured to fixedly engage with a male member secured to a restraining strap of a seatbelt disposed with said at least one seat;
a release button disposed on said latch mechanism, said release button being configured to release said latch mechanism from a fixed engagement with said male member;
an engagement sensor disposed with said latch mechanism, said engagement sensor being configured to sense said fixed engagement between said latch mechanism and said male member;
a tamper sensor disposed with said latch mechanism and said release button, said tamper sensor being configured to sense any depression of said release button; and
at least one transmitting device configured to transmit engagement data sensed by said engagement sensor and tamper data sensed by said tamper sensor to at least one indication device, said at least one indication device being configured to provide a driver of the automobile with said engagement data and said tamper data, and said at least one indication device being disposed in the automobile in a position that allows said driver to receive said engagement data and said tamper data.

2. The system of claim 1, wherein said latch mechanism further includes a locking mechanism that is configured to disable said release button from releasing said latch mechanism from a fixed engagement with said male member when said locking mechanism is activated by said driver.

3. The system of claim 2, wherein said locking mechanism is activatable by said driver via a locking actuator in communication with said locking mechanism, said locking actuator being accessible to said driver.

4. The system of claim 1, wherein said release button is spring actuated away from depression into said latch mechanism via a release button spring, said tamper sensor being configured to sense compression of said tamper release button spring.

5. The system of claim 1, wherein said at least one indication device is configured to visually display said engagement data and said tamper data on a dashboard information display of the automobile.

6. The system of claim 1, wherein said at least one indication device is configured to audibly alert said driver of at least one of said engagement data and said tamper data via an association with an audio system of the automobile.
